(19) United States
(12) Patent Application Publication
(10) Pub. No.: US 2016/0219534 A1
(43) Pub. Date: Jul. 28, 2016

(54) Method and System for Configuring a Sounding Reference Signal Power Control Parameter in a Time-Division Duplexing System

(71) Applicant: ZTE CORPORATION, Guangdong (CN)

(72) Inventors: Peng HAO, Shenzhen (CN); Weimin LI, Shenzhen (CN)

(21) Appl. No.: 15/023,408

(22) PCT Filed: May 23, 2014
(86) PCT No.: PCT/CN2014/078231

§ 371 Date: Mar. 21, 2016

(30) Foreign Application Priority Data
Sep. 27, 2013 (CN) 201310452516.5

(51) Int. Cl. H04W 52/54; H04B 1/7143; H04W 52/14; H04W 52/32; H04L 5/14

(52) U.S. Cl. CPC H04W 52/54; H04W 52/325; H04L 5/1469; H04W 52/146; H04B 1/7143

(57) ABSTRACT

A method for configuring power control parameters of sounding reference signals in a time division duplexing system is applied to a terminal and a system and includes: a terminal determining power control parameters of sounding reference signal SRS resources, and determining transmission power of the sounding reference signals based on the power control parameters; the terminal transmitting the sounding reference signals SRS based on the determined transmission power of the sounding reference signals SRS; a base station determining the power control parameters used by the terminal in the SRS resources; the base station receiving SRS signals based on the power control parameters. The embodiment of the present document also discloses a system for configuring power control parameters of sounding reference signals in a time division duplexing system, which corresponds to the abovementioned method.

### TECHNICAL FIELD

The present document relates to the field of communications, and more particularly, relates to a method for determining power control parameters of sounding reference signals in a time division duplex system.

### BACKGROUND OF THE INVENTION

FIG. 1 is a schematic diagram of a frame structure of a time division duplex (TDD) mode in the LTE system (Note: the frame structure is also called a frame structure type 2). In this frame structure, a 10 ms (307200 Ts, 1 ms=30720 Ts) radio frame is divided into two half-frames, and the length of each half-frame is 5 ms (153600 Ts). Each half-frame comprises 5 1 ms subframes, and the role of each sub-frame is as shown in Table 1, wherein D denotes a downlink subframe used for transmitting downlink signals, U denotes an uplink subframe (or called a common uplink subframe) used for transmitting uplink signals, S denotes a special subframe. In addition, one uplink or downlink subframe comprises two 0.5 ms time slots, the special subframe comprises three special time slots, namely a Downlink Pilot Time Slot (referred to as DwPTS), a Guard Period (referred to as GP) and an Uplink Pilot Time Slot (referred to as UpPTS).

TABLE 1

| Config- | Switch-point | | Subframe number | | | | | | | | | |
|---|---|---|---|---|---|---|---|---|---|---|---|---|
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

The resource allocation in the LTE system takes a Physical Resource Block (PRB, or simply a Resource Block) as the unit. As shown in FIG. 2, one PRB occupies 12 subcarriers (also known as Resource Elements (REs), and the bandwidth of each RE is 15 kHz) in the frequency domain, and occupies one time slot in the time domain. For the Normal cyclic prefix (referred to as Normal CP), one time slot comprises 7 SC-FDMA (Single Carrier-Frequency Division Multiple Access) symbols; for the Extended cyclic prefix (Extended CP), one time slot comprises 6 SC-FDMA symbols. If the total number of RBs corresponding to the uplink system bandwidth in the frequency domain is N_{RB}^{UL}, then the RB indexes are 0, 1, . . . , N−1, and the RE indexes are 0, 1, . . . , N_{RB}^{UL}·N_{SC}^{RB}−1, wherein, N_{SC}^{RB} is the number of subcarriers corresponding to one RB in the frequency domain.

The Sounding Reference Signal (SRS) is used for the uplink channel measurement, to achieve the link adaptation and power control of the PUSCH (Physical Uplink Shared Channel).

The SRS has two trigger types, respectively a trigger type 0 and a trigger type 1. The trigger type 0 is triggered via the upper-layer signaling and supports to transmit the SRS in a periodic way. The trigger type 1 is triggered via the physical layer signaling and supports to transmit the SRS in a non-periodic way. The base station reserves some resources for transmitting the trigger type 1 SRS. After a terminal receives a trigger signaling of the physical layer in the subframe n, the trigger type 1 SRS is transmitted in the subframe n+k, wherein k>=4, and n+k is an uplink sub-frame comprising the trigger type1 SRS.

The SRS resource configuration parameters mainly include: a time domain parameter, a frequency domain parameter, and a code domain parameter:

The time domain parameter specifies the time-domain location of the SRS, mainly including the SRS period and subframe offset. Wherein the cell (i.e. the cell specific) period and subframe offset specifies a time domain location where the SRS may occur in a certain cell; the terminal (i.e. the UE specific or User Equipment specific) period and subframe offset specifies a time domain location of a certain UE where the SRS may occur within a cell. The time domain location of the UE specific SRS of a certain UE within a cell is a subset of the time domain location of the cell specific SRS of the cell.

Table 1 is the cell specific SRS period and subframe offset configuration in the LTE TDD mode. Table 2 is the trigger type0 UE specific SRS period and subframe offset configuration in the LTE TDD mode. Table 3 is the trigger type1 UE specific SRS period and subframe offset configuration in the LTE TDD mode.

TABLE 1

| | | Configuration | Transmission |
|---|---|---|---|
| | | Period | offset |
| srs- | | T_{SFC} | Δ_{SFC} |
| SubframeConfig | Binary | (subframes) | (subframes) |
| 0 | 0000 | 5 | {1} |
| 1 | 0001 | 5 | {1, 2} |
| 2 | 0010 | 5 | {1, 3} |
| 3 | 0011 | 5 | {1, 4} |
| 4 | 0100 | 5 | {1, 2, 3} |
| 5 | 0101 | 5 | {1, 2, 4} |
| 6 | 0110 | 5 | {1, 3, 4} |
| 7 | 0111 | 5 | {1, 2, 3, 4} |
| 8 | 1000 | 10 | {1, 2, 6} |
| 9 | 1001 | 10 | {1, 3, 6} |
| 10 | 1010 | 10 | {1, 6, 7} |
| 11 | 1011 | 10 | {1, 2, 6, 8} |
| 12 | 1100 | 10 | {1, 3, 6, 9} |
| 13 | 1101 | 10 | {1, 4, 6, 7} |
| 14 | 1110 | Reserved | reserved |
| 15 | 1111 | Reserved | reserved |

TABLE 2

| SRS | SRS | SRS Subframe |
|---|---|---|
| Configuration | Periodicity | Offset |
| Index I_{SRS} | T_{SRS} (ms) | T_{offset} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS}-10 |
| 15-24 | 10 | I_{SRS}-15 |
| 25-44 | 20 | I_{SRS}-25 |
| 45-84 | 40 | I_{SRS}-45 |
| 85-164 | 80 | I_{SRS}-85 |
| 165-324 | 160 | I_{SRS}-165 |
| 325-644 | 320 | I_{SRS}-325 |
| 645-1023 | reserved | reserved |

TABLE 3

| SRS Configuration | SRS Periodicity | SRS Subframe Offset |
|---|---|---|
| Index I_{SRS} | T_{SRS,1} (ms) | T_{offset,1} |
| 0 | 2 | 0, 1 |
| 1 | 2 | 0, 2 |
| 2 | 2 | 1, 2 |
| 3 | 2 | 0, 3 |
| 4 | 2 | 1, 3 |
| 5 | 2 | 0, 4 |
| 6 | 2 | 1, 4 |
| 7 | 2 | 2, 3 |
| 8 | 2 | 2, 4 |
| 9 | 2 | 3, 4 |
| 10-14 | 5 | I_{SRS}-10 |
| 15-24 | 10 | I_{SRS}-15 |
| 25-31 | reserved | reserved |

NOTE: in Table 2 and Table 3, the SRS Subframe Offset being 0, 1, 5, 6 indicates: when there are two SC-FDMA symbols within the UpPTS, the subframe offset 0 or 5 represents the first SC-FDMA symbol of the UpPTS in the first or second half-frame, the subframe offset 1 or 6 represents the second SC-FDMA symbol of the UpPTS in the first or second half-frame; when there is one SC-FDMA symbol within the UpPTS, the subframe offset 1 or 6 represents the only SC-FDMA symbol of the UpPTS in the first or second half-frame.

The frequency domain parameter specifies the frequency domain location of the SRS, mainly including an SRS bandwidth related configuration parameter, a frequency domain starting location, a frequency domain comb configuration, and a frequency hopping parameter;

the SRS bandwidth is configured in a tree structure, i.e., each SRS bandwidth configuration corresponds to one tree structure, as shown in FIG. 3. Wherein, the highest-layer SRS-Bandwidth corresponds to the maximum bandwidth of the SRS bandwidth configuration, Table 4 shows the SRS bandwidth configuration when the uplink system bandwidth is 6≦N_{RB}^{UL}≦40. Take the SRS bandwidth configuration 1 in Table 2 for example, b=0 is the first layer, and it is the highest layer of the tree structure, the SRS bandwidth of the layer is the bandwidth corresponding to 32 PRBs and is the maximum SRS bandwidth of the SRS bandwidth configuration; b=1 is the second layer, the SRS bandwidth of the layer is the bandwidth corresponding to 16 PRBs, and one SRS bandwidth of the first layer is split into two SRS-bandwidths of the second layer; b=2 is the third layer, the SRS bandwidth of the layer is the bandwidth corresponding to 8 PRBs, and one SRS bandwidth of the second layer is split into two SRS bandwidths of the third layer; b=3 is the fourth layer, the SRS bandwidth of the layer is the bandwidth corresponding to four PRBs and one SRS bandwidth of the third layer is split into two SRS bandwidths of the fourth layer. In addition, subcarriers of SRS signals in the same SRS frequency band are spaced, as shown in FIG. 3, this comb structure allows more users to transmit SRS signals in the same SRS bandwidth.

TABLE 4
(6 ≦ N_{RB}^{UL} ≦ 40)

| SRS | SRS-Bandwidth [symbol] | | SRS-Bandwidth [symbol] | | SRS-Bandwidth [symbol] | | SRS-Bandwidth [symbol] | |
|---|---|---|---|---|---|---|---|---|
| bandwidth | b = 0 [symbol] | | B = 1 [symbol] | | B = 2 [symbol] | | B = 3 [symbol] | |
| configuration [symbol] | m_{SRS, b} [symbol] | N_{b} [symbol] | m_{SRS, b} [symbol] | N_{b} [symbol] | m_{SRS, b} [symbol] | N_{b} [symbol] | m_{SRS, b} [symbol] | N_{b} [symbol] |
| 0 [symbol] | 36 [symbol] | 1 [symbol] | 12 [symbol] | 3 [symbol] | 4 [symbol] | 3 [symbol] | 4 [symbol] | 1 [symbol] |
| 1 [symbol] | 32 [symbol] | 1 [symbol] | 16 [symbol] | 2 [symbol] | 8 [symbol] | 2 [symbol] | 4 [symbol] | 2 [symbol] |
| 2 [symbol] | 24 [symbol] | 1 [symbol] | 4 [symbol] | 6 [symbol] | 4 [symbol] | 1 [symbol] | 4 [symbol] | 1 [symbol] |
| 3 [symbol] | 20 [symbol] | 1 [symbol] | 4 [symbol] | 5 [symbol] | 4 [symbol] | 1 [symbol] | 4 [symbol] | 1 [symbol] |
| 4 [symbol] | 16 [symbol] | 1 [symbol] | 4 [symbol] | 4 [symbol] | 4 [symbol] | 1 [symbol] | 4 [symbol] | 1 [symbol] |
| 5 [symbol] | 12 [symbol] | 1 [symbol] | 4 [symbol] | 3 [symbol] | 4 [symbol] | 1 [symbol] | 4 [symbol] | 1 [symbol] |
| 6 [symbol] | 8 [symbol] | 1 [symbol] | 4 [symbol] | 2 [symbol] | 4 [symbol] | 1 [symbol] | 4 [symbol] | 1 [symbol] |
| 7 [symbol] | 4 [symbol] | 1 [symbol] | 4 [symbol] | 1 [symbol] | 4 [symbol] | 1 [symbol] | 4 [symbol] | 1 [symbol] |

If the allocated SRS bandwidth is relatively small, the UE can measure channels in a wider bandwidth range through frequency hopping. FIG. 3 is taken as an example, when the allocated bandwidth is in the second layer (i.e. b=1), namely when the SRS bandwidth is 16RB, at the time points t and t+1 of transmitting the SRS, the UE can transmit SRS signals in the left and right two SRS frequency bands respectively.

The code domain parameter specifies a sequence used by the SRS and a cyclic offset thereof.

In the LTE R11 and previous systems, the following equation is adopted to calculate the SRS transmission power at the time point i:

P_{SRS,c}(i)=min{P_{CMAX,c}(i),P_{SRS}_{_}_{OFFSET,c}(m)+10 log₁₀(M_{SRS,c})+P_{O}_{_}_{PUSCH,c}(j)+α_{c}(j)·PL_{c}+f_{c}(i)}

wherein,

P_{CMAX,c}(i) is the maximum configurable transmission power of the UE;

P_{SRS}_{_}_{OFFSET,c}(m) is the power offset parameter (m=0 is the trigger type0, and m=1 is the trigger type1);

M_{SRS,c} is the SRS bandwidth;

f_{c}(i) is the power control adjustment state of the current PUSCH in the cell c based on the TPC (Transmit Power Control) command. For the cumulative mode, f_{c}(i)=f_{c}(i−1)+δ_{PUSCH,c}(i−K_{PUSCH}); and for the non-cumulative mode, f_{c}(i)=δ_{PUSCH,c}(i−K_{PUSCH})·δ_{PUSCH,c} (i−K_{PUSCH}) is the TPC command received at the time point i−K_{PUSCH}.

P_{O}_{_}_{PUSCH,c}(j) and α_{c}(j) are open loop power control parameters used by the PUSCH; P_{O}_{_}_{PUSCH,c} consists of two parts: P_{O}_{_}_{NOMINAL}_{_}_{PUSCH,c} and P_{O}_{_}_{UE}_{_}_{PUSCH,c}, the P_{O}_{_}_{NOMINAL}_{_}_{PUSCH,c} is the cell specific parameter configured by the upper layer in the cell c, and the P_{O}_{_}_{UE}_{_}_{PUSCH,c} is the UE specific parameter configured by the upper layer in the cell c; j corresponds to the grant type of the PUSCH, i.e., j=0 is the semi-persistent grant, j=1 is the dynamic scheduled grant, and j=2 is the random access response grant;

PL_{c} is the path loss;

Note: See 36.213 for a detailed explanation of the abovementioned equation.

The LTE R12 TDD mode introduced the dynamic sub-frame technology, wherein the dynamic subframe can flexibly change the transmission direction. When the dynamic sub-frame technology is applied, interference intensities that various uplink subframes (including fixed uplink subframes and dynamic subframes) face are different. Therefore, it needs to divide the uplink sub-frames into a plurality of subframe groups, and the interference faced by each of the subframe groups is withstood by configuring the PUSCH channel of each subframe group with different power control parameters (P_{O}_{_}_{PUSCH,c}(i), α_{c}(i), f_{c}(i)).

The base station must know the power deviation between the SRS and the PUSCH, so that the reception power of the PUSCH can be estimated by using the measurement result of the SRS, which achieves the power control and link adaptation for the PUSCH. Because the base station does not know the path loss between the base station itself and the terminal, when the PUSCHs of different subframe groups use different α_{c}(i), if only one set of power control parameters is configured for the SRS, the base station cannot estimate the reception powers of the PUSCH channels in two subframe groups. On the other hand, the power control adjustment states (f_{c}(i)) of the PUSCHs of different subframe groups may be different, and the closed loop power control command may be lost, thus the base station cannot know exactly how many power control adjustment commands has the terminal already received, at this time, it also needs to respectively transmit the SRS signals based on the power control adjustment states of the two subframe groups.

In summary, how to transmit SRS signals based on a plurality of sets of power control parameters is a problem to be solved urgently when it is to achieve the dynamic subframe technology in the LTE TDD mode. The current solution is to use the power control parameters of the subframe group in which the SRS is transmitted, and the disadvantages of this method include:

(1) when all subframes in one subframe group can change their transmission directions and are used for the downlink transmission in a period of time, the channel measurement cannot be achieved based on the power control parameters of the subframe group. When there are uplink data, the uplink transmission cannot be achieved in time in the subframe group;

(2) typically the fixed uplink subframes are grouped into one group, and the flexible subframes are grouped into another group. As shown in FIG. 4, in this case, when the SRS period is greater than or equal to 5 ms, it cannot be guaranteed that there are SRS resources within both two subframe groups in many cases; and if the 2 ms period is used, the SRS overhead will be greatly increased.

(3) in the LTE TDD mode, the UpPTS can be used to transmit SRS signals, so as to save the ordinary uplink subframe resources for the data transmission. Since the UpPTS is fixedly used for the uplink transmission, it is often allocated to a certain subframe group. At this time, it needs to allocate the SRS resources in the uplink subframes, which increases the overhead.

(4) when transmission directions of all subframes in one subframe group can be changed, it is required to notify the terminal of the transmission directions of dynamic subframes through a signaling in the method, so that when the dynamic subframes are uplink, the SRS using the power control parameters of the subframe group is transmitted.

### SUMMARY OF THE INVENTION

The present document discloses a method and system for configuring power control parameters of sounding reference signals in a time division duplex system, which can better solve the problem of using a plurality of sets of power control parameters to transmit SRS signals. The specific contents comprise that:

the present document discloses a method for configuring power control parameters of sounding reference signals in a time division duplex system, applied to a terminal, comprising:

a terminal determining power control parameters of sounding reference signal SRS resources, and determining transmission power of sounding reference signals according to the power control parameters;

the terminal transmitting the sounding reference signals SRS according to determined transmission power of the sounding reference signals SRS.

Preferably,

the power control parameters comprise at least one of the following P_{O}_{_}_{PUSCH,c}, α_{c}, f_{c}, P_{O}_{_}_{NOMINAL}_{_}_{PUSCH,c} and P_{O}_{_}_{UE}_{_}_{PUSCH,c}, wherein, f_{c} is a power control adjustment state of a current PUSCH in a cell c based on a TPC (Transmit Power Control) command; P_{O}_{_}_{PUSCH,c} P_{O}_{_}_{NOMINAL}_{_}_{PUSCH,c}, P_{O}_{_}_{UE}_{_}_{PUSCH,c} and α_{c} are power control parameters used by a physical uplink shared channel PUSCH P_{O}_{_}_{NOMINAL}_{_}_{PUSCH,c} is a cell-specific parameter; P_{O}_{_}_{UE}_{_}_{PUSCH,c} is a terminal-specific parameter; and Pₒ_{_}_{PUSCH,c}=P_{O}_{_}_{NOMINAL}_{_}_{PUSCH,c}+P_{O}_{_}_{UE}_{_}_{PUSCH,c}.

Preferably,

said determining the transmission power according to the power control parameters comprises one of the following variables or the sum of a plurality of the following variables: P_{O}_{_}_{PUSCH,c}, α_{c}·PL_{c}, f_{c}, wherein, a unit of P_{O}_{_}_{PUSCH,c} is dBm, and a unit of f_{c} and PL_{c} is dB.

Preferably, the SRS resources comprise at least one of the following: a time domain location, a frequency domain location, a frequency domain comb, and a sequence cyclic shift.

Preferably, the terminal determining the power control parameters of the sounding reference signal SRS resources comprises:

the terminal determining the power control parameters according to SRS processes configured by a base station, wherein different SRS processes comprise different SRS resources, and the different SRS resources or different SRS processes correspond to different power control parameters.

Preferably, when there is one SRS process, SRS resources corresponding to the SRS process use same power control parameters.

Preferably, when all subframes for the terminal transmitting the physical uplink shared channel PUSCH belong to one subframe group, a number of the SRS processes is 1.

Preferably, the terminal determining the power control parameters of the sounding reference signal SRS resources comprises:

the terminal determining power control parameters used at different time domain locations.

Preferably, when there are two power control parameters, power control parameters used by the terminal at same frequency domain locations between adjacent frequency hopping periods are different.

Preferably,

in a same hop period, different power control parameters are used alternately between adjacent time domain locations, and/or, different power control parameters are used alternately at corresponding time domain locations in combinations of adjacent two time domain locations in a same frequency hopping period, and/or, same power control parameters are used at each time domain location within a same frequency hopping period.

Preferably, the method is applied when two antennas are utilized to close an antenna selection function.

Preferably, when there are two power control parameters and two antennas are utilized to open an antenna selection function, after alternately using two power control parameters to transmit the SRS at same frequency domain locations in adjacent two frequency hopping periods by using one antenna, the terminal alternately uses two power control parameters to transmit the SRS at same frequency domain locations in another adjacent two frequency hopping periods by using the other antenna.

Preferably,

in a same frequency hopping period, different power control parameters are alternately used between adjacent time domain locations, and/or, different power control parameters are alternately used at corresponding time domain locations in combinations of adjacent two time domain locations in a same frequency hopping period, and/or, same power control parameters are used at each time domain location within a same frequency hopping period.

Preferably, when there are two power control parameters and two antennas are utilized to open an antenna selection function, after alternately using two antennas to transmit the SRS at same frequency domain locations in adjacent two frequency hopping periods by using one power control parameter, the terminal alternately uses two antennas to transmit the SRS at same frequency domain locations in another adjacent two frequency hopping periods by using the other power control parameter.

Preferably,

different antennas are used alternately between adjacent time domain locations in a same frequency hopping period, and/or, different antennas are used alternately at corresponding time domain locations in combinations of adjacent two time domain locations in a same frequency hopping period.

Preferably, the terminal determining power control parameters of sounding reference signal SRS resources comprises:

the terminal determining the power control parameters of the SRS resources according to a signaling indication of the base station.

Preferably, the terminal determining the power control parameters of the SRS resources according to the signaling indication of the base station comprises: the terminal receiving a physical layer signaling from the base station, when the signaling indicatesan SRS resource configuration used by the terminal, the terminal determining power control parameters corresponding to the SRS resource configuration according to an association relationship between SRS resource configurations and power control parameters.

Preferably, the physical layer signaling is a DCI (Downlink Control Information) format 4.

Preferably, the SRS resource configurations comprise at least one of the following: a frequency domain comb configuration, a starting physical resource block index, a period and subframe offset configuration, an SRS bandwidth configuration, a sequence cyclic shift configuration, and a configuration of a number of antenna ports.

Preferably, the SRS resources are used for a trigger type0 SRS and/or a trigger type1 SRS.

Preferably, when the SRS resources are used for the trigger type1 SRS, the terminal determining a time domain location for transmitting the SRS and corresponding power control parameters according to a time domain location of a physical layer trigger signaling.

Preferably, the terminal determining the time domain location for transmitting the SRS according to the time domain location of the physical layer trigger signaling comprises: if the time domain location of the physical layer trigger signaling is a subframe n, the time domain location for transmitting the SRS being n+k, wherein k≧4 and subframes n+k are uplink subframes comprising the SRS resources.

Preferably,

the uplink subframes comprise fixed uplink subframes and/or uplink subframes converted from dynamic subframes, the dynamic subframes are different subframes in different periods and transmission directions, and the periods are less than 640 milliseconds.

Preferably,

the terminal uses same power configuration parameters in all SRS resources according to the configuration of the base station.

A method for configuring power control parameters of sounding reference signals in a time division duplex system, applied to a base station, comprising: the base station determining power control parameters used by a terminal in SRS resources;

the base station receiving SRS signals according to the power control parameters.

Preferably,

the power control parameters comprise at least one of the following P_{O}_{_}_{PUSCH,c}, α_{c}, f_{c}, P_{O}_{_}_{NOMINAL}_{_}_{PUSCH,c} and P_{O}_{_}_{UE}_{_}_{PUSCH,c},wherein, f_{c} is a power control adjustment state of a current PUSCH in a cell c based on a TPC (Transmit Power Control) command; P_{O}_{_}_{PUSCH,c}, P_{O}_{_}_{NOMINAL}_{_}_{PUSCH,c}, P_{O}_{_}_{UE}_{_}_{PUSCH,c} and α_{c} are power control parameters used by the physical uplink shared channel PUSCH. P_{O}_{_}_{NOMINAL}_{_}_{PUSCH,c} is a cell-specific parameter; P_{O}_{_}_{UE}_{_}_{PUSCH,c} is a terminal-specific parameter; and P_{O}_{_}_{PUSCH,c}=P_{O}_{_}_{NOMINAL}_{_}_{PUSCH,c}+P_{O}_{_}_{UE}_{_}_{PUSCH,c}.

Preferably,

determining transmission power according to the power control parameters comprises one of the following variables or the sum of a plurality of the following variables: P_{O}_{_}_{PUSCH,c}, α_{c}·PL_{c}, f_{c}, wherein, a unit of P_{O}_{_}_{PUSCH,c} is dBm, and a unit of f_{c} and PL_{c} is dB.

Preferably, the SRS resources comprise at least one of the following: a time domain location, a frequency domain location, a frequency domain comb, and a sequence cyclic shift.

Preferably, the base station determining the power control parameters used by the terminal in the SRS resources comprises:

the base station configuring SRS processes for the terminal, wherein different SRS processes comprise different SRS resources, and the different SRS resources or the different SRS processes correspond to different power control parameters.

Preferably, when there is one SRS process, the SRS resources corresponding to the SRS process use same power control parameters.

Preferably, when all subframes for the terminal transmitting the physical uplink shared channel PUSCH belong to one subframe group, there is one SRS process.

Preferably, the base station determining the power control parameters used by the terminal in the SRS resources comprises:

the base station determining the power control parameters used by the terminal at different time domain locations.

Preferably, when there are two power control parameters, the power control parameters used by the terminal at same frequency domain locations in adjacent frequency hopping periods are different.

Preferably,

in a same frequency hopping period, different power control parameters are used alternately in adjacent time domain locations, and/or, different power control parameters are used alternately at corresponding time domain locations in combinations of adjacent two time domain locations in a same frequency hopping period, and/or, same power control parameters are used at each time domain location within a same frequency hopping period.

Preferably, the method is applied when two antennas are utilized to close an antenna selection function.

Preferably, when there are two power control parameters and two antennas are utilized to open an antenna selection function, after alternately using two power control parameters to transmit the SRS at same frequency domain locations in adjacent two frequency hopping periods by using one antenna, the terminal alternately uses two power control parameters to transmit the SRS at same frequency domain locations in another adjacent two frequency hopping periods by using the other antenna.

Preferably,

in a same frequency hopping period, different power control parameters are alternately used at adjacent time domain locations, and/or, different power control parameters are alternately used at corresponding time domain locations in combinations of adjacent two time domain locations in a same frequency hopping period, and/or, same power control parameters are used at each time domain location within a same frequency hopping period.

Preferably, when there are two power control parameters and two antennas are utilized to open an antenna selection function, after alternately using two antennas to transmit the SRS at same frequency domain locations in adjacent two frequency hopping periods by using one power control parameter, the terminal alternately uses two antennas to transmit the SRS at same frequency domain locations in another adjacent two frequency hopping periods by using the other power control parameter.

Preferably,

different antennas are used alternately at adjacent time domain locations in a same frequency hopping period, and/or, different antennas are used alternately at corresponding time domain locations in combinations of adjacent two time domain locations in a same frequency hopping period.

Preferably, the base station determining power control parameters used by the terminal in the SRS resources comprises:

the base station indicates the terminal to determine the power control parameters of the SRS resources through a signaling.

Preferably, the base station indicating the terminal to determine the power control parameters of the SRS resources through the signaling comprises: the base station transmitting a physical layer signaling to the terminal, when the signaling indicates an SRS resource configuration used by the terminal, the terminal determining power control parameters corresponding to the SRS resource configuration according to an association relationship between SRS resource configurations and power control parameters.

Preferably, the physical layer signaling is a DCI (Downlink Control Information) format 4.

Preferably,

the SRS resource configurations comprise at least one of the following: a frequency domain comb configuration, a starting physical resource block index, a period and subframe offset configuration, an SRS bandwidth configuration, a cyclic shift configuration, and a configuration of a number of antenna ports.

Preferably, the SRS resources are used for a trigger type0 SRS and/or a trigger type1 SRS.

Preferably,

when the SRS resources are used for the trigger type1 SRS, the base station determines a time domain location for transmitting the SRS and corresponding power control parameters according to a time domain location of the physical layer trigger signaling.

Preferably, the base station determining the time domain location for transmitting the SRS base on the time domain location of the physical layer trigger signaling comprises: if the time domain location of the physical layer trigger signaling is a subframe n, the time domain location for transmitting the SRS being n+k, wherein k≧4 and subframes n+k are uplink subframes comprising the SRS resources.

Preferably, the uplink subframes comprise fixed uplink subframes and/or uplink subframes converted from dynamic subframes, the dynamic subframes may be different subframes in different periods and transmission directions, and the periods are less than 640 milliseconds.

Preferably,

the base station uses same power configuration parameters in all SRS resources through a signaling configuration.

A system for configuring power control parameters of sounding reference signals in a time division duplex system, applied to a terminal, comprising:

a power control parameter determining module, configured to: determine power control parameters of sounding reference signal SRS resources;

a transmission power determining module, configured to: determine transmission power of the sounding reference signals according to the power control parameters;

a transmitting module, configured to: transmit the sounding reference signals SRS according to determined transmission power of the sounding reference signals SRS.

A system for configuring power control parameters of sounding reference signals in a time division duplex system, applied to a base station, comprising:

a power control parameter determining module, configured to: determine power control parameters used by a terminal in SRS resources;

a receiving module, configured to: receive SRS signals according to the power control parameters.

The beneficial effects of the embodiments of the present document are that:

(1) the flexibility is better, and the uplink resource utilization rate can be improved. Based on the method proposed in the present document, the SRS using different power control parameters can be transmitted in any uplink subframes (including fixed uplink subframes, dynamic subframes and UpPTS), and it is not required that the SRS period be less than 5 ms. When the SRS is transmitted in the UpPTS, the uplink subframe resources can be saved for data transmission. When the SRS period is greater than 5 ms, the SRS overhead can be reduced.

(2) when the transmission direction of the subframes is changed, the transmission of SRS with different power control parameters and the corresponding channel measurement are not affected, which ensures the PUSCH power control and link adaptation performance of each subframe group.

(3) the method provided in the embodiments of the present document supports to transmit the SRS in fixed uplink subframes for different power control parameters, thus the dependence on the subframe transmission direction related signaling is not high.

### BRIEF DESCRIPTION OF THE DRAWINGS

FIG. 1 is a schematic diagram of a frame structure of a TDD mode in an LTE system;

FIG. 2 is a schematic diagram of the structure of a physical resource block;

FIG. 3 is a schematic diagram of an SRS signal frequency domain configuration;

FIG. 4 is a schematic diagram of working in a traditional method when the SRS period equals to 5 ms;

FIG. 5 is a first embodiment (the number of frequency hopping locations is 4);

FIG. 6 is the first embodiment (the number of frequency hopping locations is 3);

FIG. 7 is a schematic diagram of a second embodiment;

FIG. 8 is a schematic diagram of a third embodiment;

FIG. 9 is a schematic diagram of a fourth embodiment;

FIG. 10 is a schematic diagram of a fifth embodiment (the number of frequency hopping locations is 3);

FIG. 11 is a schematic diagram of the fifth embodiment (the number of frequency hopping locations is 2);

FIG. 12 is a schematic diagram of the fifth embodiment (the number of frequency hopping locations is 4);

FIG. 13 is a schematic diagram of a sixth embodiment;

FIG. 14 a schematic diagram of a seventh embodiment (Trigger type0 SRS).

FIG. 15 a schematic diagram of the seventh embodiment (Trigger type1 SRS).

FIG. 16 is a schematic diagram of an eighth embodiment;

FIG. 17 is a schematic diagram of a ninth embodiment (the number of frequency hopping locations is 3);

FIG. 18 is a schematic diagram of the ninth embodiment (the number of frequency hopping locations is 4);

FIG. 19 is a schematic diagram of the tenth embodiment (the number of frequency hopping locations is 3);

FIG. 20 is a schematic diagram of the tenth embodiment (the number of frequency hopping locations is 4);

FIG. 21 is a flow chart of a method (applied to a terminal) in an embodiment of the present document;

FIG. 22 is a flow chart of a method (applied to a base station) in an embodiment of the present document;

FIG. 23 is a block diagram of a system (applied to the terminal) in an embodiment of the present document.

FIG. 24 is a block diagram of a system (applied to the terminal) in an embodiment of the present document.

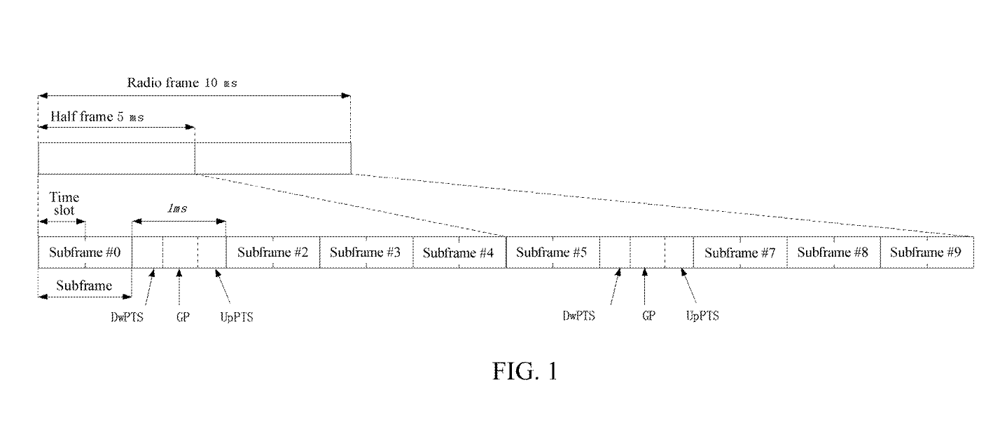

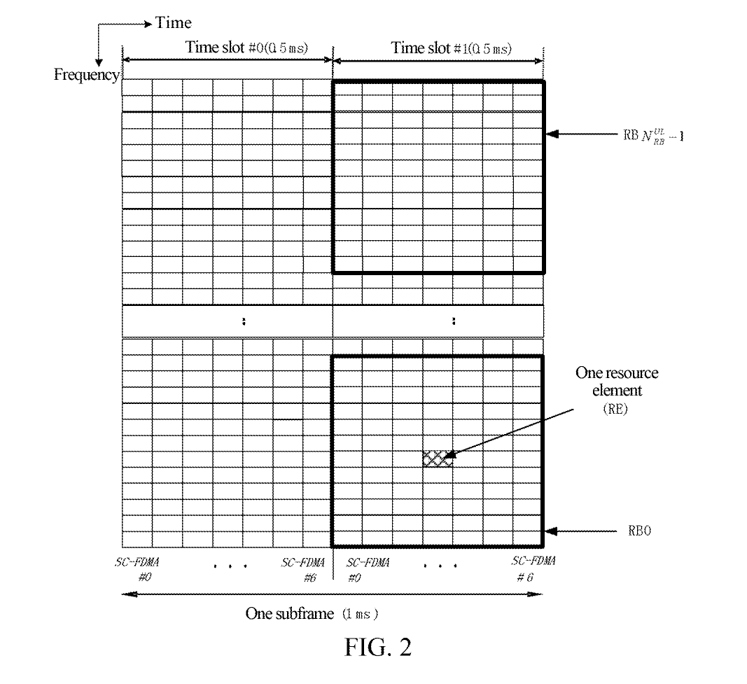

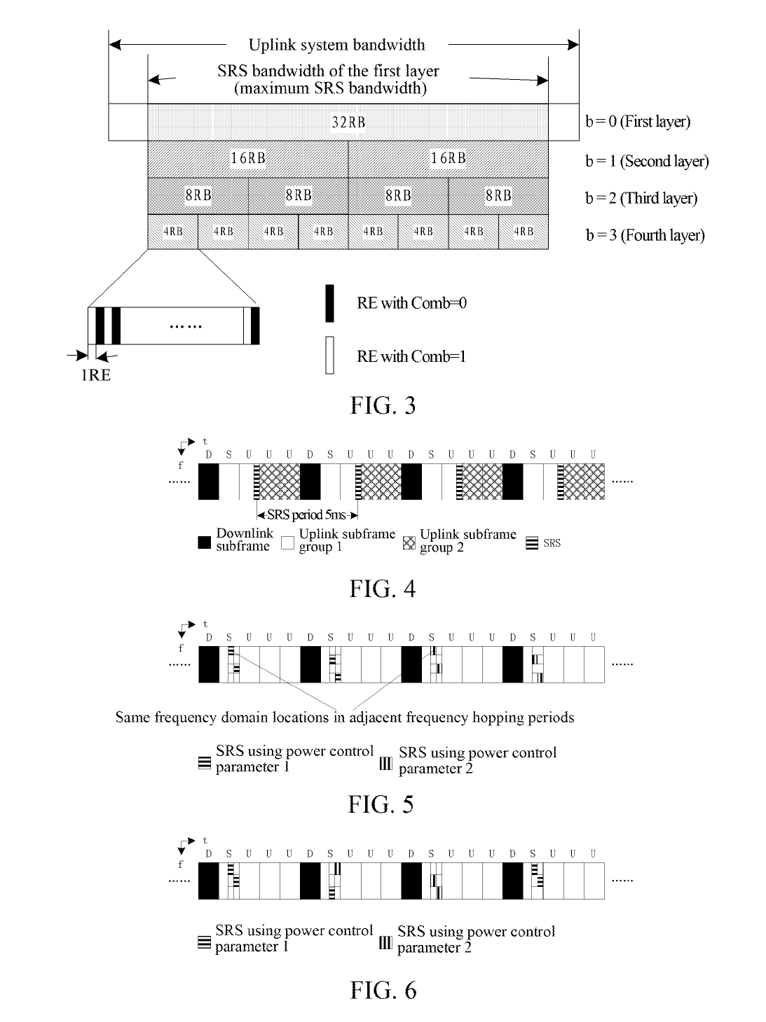

### PREFERRED EMBODIMENTS OF THE INVENTION

Hereinafter, the present document will be described in detail in conjunction with the accompanying drawings.

### Method Embodiment

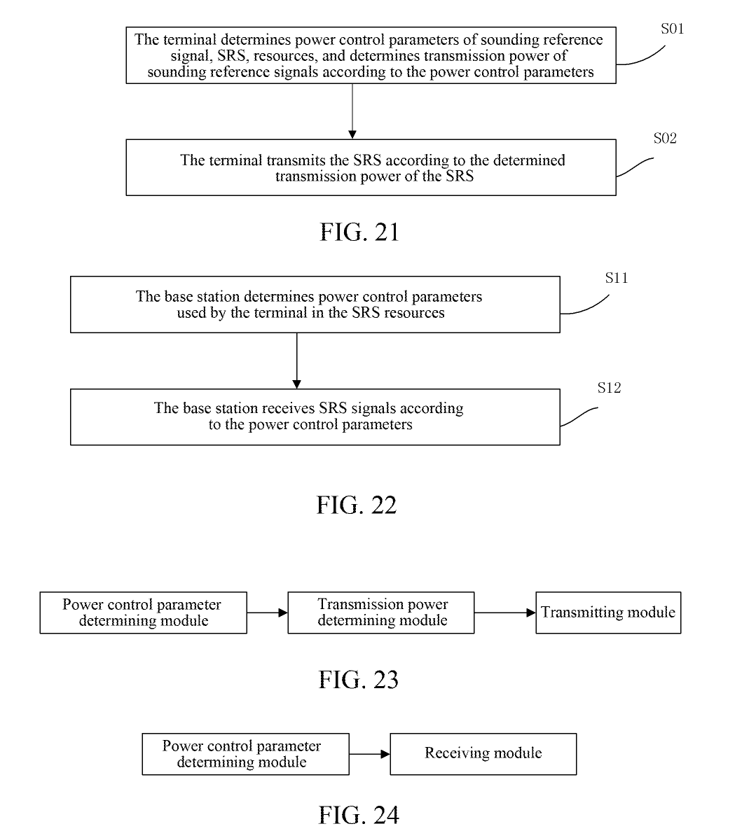

The embodiment of the present document discloses a method for configuring power control parameters of sounding reference signals in a time division duplex system, respectively applied to a terminal and a base station, as shown in FIG. 21 and FIG. 22:

A method for configuring power control parameters of sounding reference signals in a time division duplex system, applied to a terminal, including:

S01. The terminal determines power control parameters of sounding reference signal SRS resources, and determines transmission power of sounding reference signals according to the power control parameters.

S02. The terminal transmits the sounding reference signals SRS according to the determined transmission power of the sounding reference signals SRS.

A method for configuring power control parameters of sounding reference signals in a time division duplex system, applied to a base station, including:

S11. The base station determines power control parameters used by the terminal in the SRS resources.

S12. The base station receives the SRS signals according to the power control parameters.

### The First Embodiment

One power control parameter consists of P_{O}_{_}_{PUSCH,c}, α_{c} and f_{c}. There are two power control parameters in total, respectively a power control parameter 1: <P¹_{O}_{_}_{PUSCH,c}, α_{c}¹, f_{c}¹> and a power control parameter 2: <P²_{O}_{_}_{PUSCH,c}, α_{c}², f_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH,c}, or different P_{O}_{_}_{UE}_{_}_{PUSCH,c}, or different P_{O}_{_}_{NOMINAL}_{_}_{PUSCH,c} and P_{O}_{_}_{UE}_{_}_{PUSCH,c}.

SRS resources refer to: time domain location and/or frequency domain location. Different SRS resources using different power control parameters refers to using different power control parameters at different time domain locations and/or frequency domain locations. The SRS resources are within the UpPTS, and two symbols within one UpPTS are used for the SRS (2 ms period) and the SRS resources are used for the Trigger type0 SRS.

FIG. 5 shows the case of alternately using the power control parameters 1 and 2 in each frequency hopping period (in FIG. 5, 4 SC-FDMA symbols is one frequency hopping period) when there are 4 frequency hopping locations: the power control parameters used by the terminal at the same frequency domain locations in adjacent frequency hopping periods are different. The same power control parameters are used at each time domain location within a same frequency hopping period.

FIG. 6 shows the case of alternately using the power control parameters 1 and 2 in each frequency hopping period (in FIG. 6, 3 SC-FDMA symbols is one frequency hopping period) when there are 3 frequency hopping locations: the power control parameters used by the terminal at the same frequency domain locations in adjacent frequency hopping periods are different. The same power control parameters are used at each time domain location within a same frequency hopping period.

### The Second Embodiment

One power control parameter consists of α_{c} and f_{c}. There are two power control parameters in total, respectively a power control parameter 1: <α_{c}¹, f_{c}¹> and a power control parameter 2: <α_{c}², f_{c}²>.

SRS resources refer to: time domain location and/or frequency domain location. Different SRS resources using different power control parameters refers to using different power control parameters at different time domain locations and/or frequency domain locations.

It is assumed that the Trigger type0 SRS is transmitted in the subframes 2 and 7.

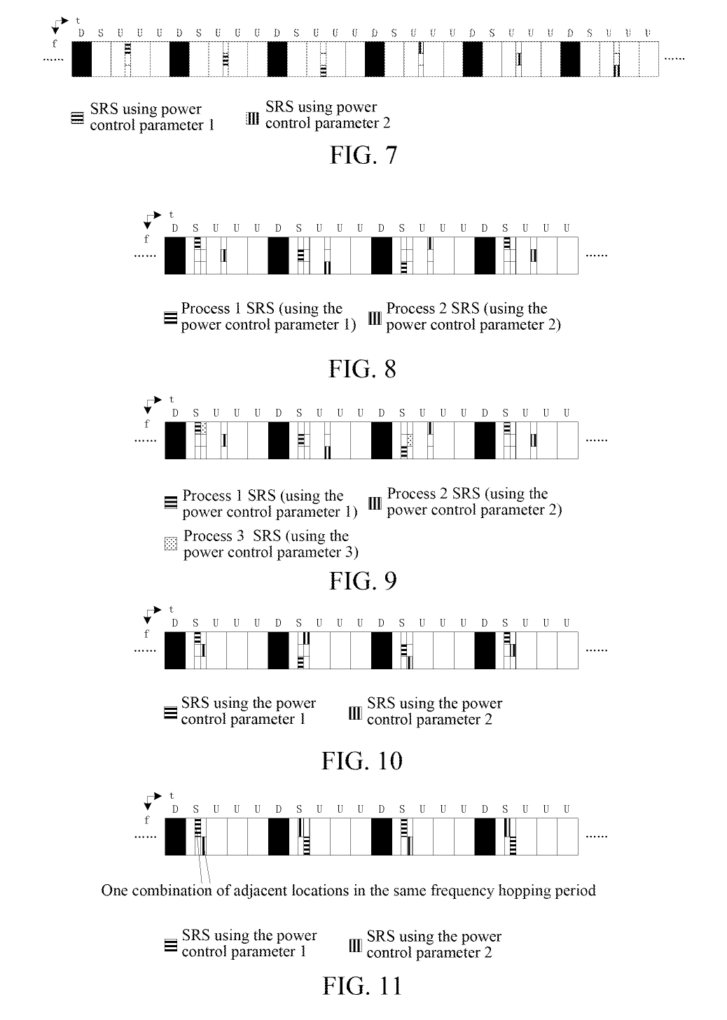

FIG. 7 shows the case of alternately using the power control parameters 1 and 2 in each frequency hopping period when there are 3 frequency hopping locations: the power control parameters used by the terminal at the same frequency domain locations in adjacent frequency hopping periods are different. The same power control parameters are used at each time domain location in a same frequency hopping period.

### The Third Embodiment

One power control parameter consists of P_{O}_{_}_{PUSCH,c} and α_{c}. There are two power control parameters in total, respectively a power control parameter 1: <P¹_{O}_{_}_{PUSCH,c}, α_{c}¹> and a power control parameter 2: <P²_{O}_{_}_{PUSCH,c}, α_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH,c}, or different P_{O}_{_}_{UE}_{_}_{PUSCH,c} or different P_{O}_{_}_{NOMINAL}_{_}_{PUSCH,c} and P_{O}_{_}_{UE}_{_}_{PUSCH,c}.

2 SRS processes are configured. Time domain locations of the two SRS processes are different (individually configured through the period and subframe offset) and frequency domain locations are different (individually configured through the frequency domain starting PRB and/or frequency hopping parameters).

As shown in FIG. 8, for the Trigger type0 SRS, it is assumed that the period of the process 1 is 5 ms and the subframe offset is 0; the period of the process 2 is 5 ms and the subframe offset is 2; the process 1 uses the power control parameter 1 and the process 2 uses the power control parameter 2.

In addition, the processes 1 and 2 may also use different frequency domain combs, for example, the process 1 uses a frequency domain comb configuration 0 and the process 2 uses a frequency domain comb configuration 1; the processes 1 and 2 may also use different cyclic shifts, for example, the process 1 uses a cyclic shift 0 and the process 2 uses a cyclic shifts 4.

### The Fourth Embodiment

One power control parameter consists of P_{O}_{_}_{PUSCH,c} and α_{c}. There are three power control parameters in total, respectively a power control parameter 1: <P¹_{O}_{_}_{PUSCH,c}, α_{c}¹>, a power control parameter 2: <P²_{O}_{_}_{PUSCH,c}, α_{c}²>; and a power control parameter 3: <P³_{O}_{_}_{PUSCH,c}, α_{c}³>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c}. P²_{O}_{_}_{PUSCH,c} and P³_{O}_{_}_{PUSCH,c} may have different P_{O}_{_}_{NOMINAL}_{_}_{PUSCH,c} or different P_{O}_{_}_{UE}_{_}_{PUSCH,c} or different P_{O}_{_}_{NOMINAL}_{_}_{PUSCH,c} and P_{O}_{_}_{UE}_{_}_{PUSCH,c}.

3 SRS processes are configured. Time domain locations of the three SRS processes are different (individually configured through the period and subframe offset).

As shown in FIG. 9, for the Trigger type0 SRS, it is assumed that the period of the process 1 is 5 ms, and the subframe offset is 0; the period of the process 2 is 5 ms, and the subframe offset is 2; the period of the process 3 is 10 ms, and the subframe offset is 1; the processes 1, 2 and 3 respectively use the power control parameters 1, 2 and 3.

### The Fifth Embodiment

One power control parameter consists of P_{O}_{_}_{PUSCH,c} and f_{c}. There are two power control parameters in total, respectively a power control parameter 1: <P¹_{O}_{_}_{PUSCH,c}, f_{c}¹> and a power control parameter 2: <P²_{O}_{_}_{PUSCH,c}, f_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH,c} or different P_{O}_{_}_{UE}_{_}_{PUSCH,c}, or different P_{O}_{_}_{NOMINAL}_{_}_{PUSCH,c} and P_{O}_{_}_{UE}_{_}_{PUSCH,c}.

SRS resources refer to: time domain location and/or frequency domain location. Different SRS resources using different power control parameters refers to using different power control parameters at different time domain locations and/or frequency domain locations.

It is assumed that the Tigger type0 SRS is transmitted in the UpPTS, and two symbols within one UpPTS are used for the SRS (2 ms period).

FIG. 10 shows the case of using different power control parameters at adjacent SRS transmission time points when there are 3 frequency domain hopping locations: the power control parameters used by the terminal at the same frequency domain locations in the adjacent frequency hopping periods are different; within a same frequency hopping period, different power control parameters are used alternately between adjacent time domain locations.

FIG. 11 shows the case of alternately using the same or different power control parameters at adjacent SRS transmission time points when there are 2 frequency domain hopping locations: the power control parameters used by the terminal at the same frequency domain locations between the adjacent frequency hopping periods are different; different power control parameters are alternately used between adjacent time domain locations in a same frequency hopping period. It is also equivalent to: different power control parameters being alternately used at the corresponding time domain locations in the combinations of two adjacent time domain locations within a same frequency hopping period (the number of combinations of adjacent locations within one frequency hopping period is 1).

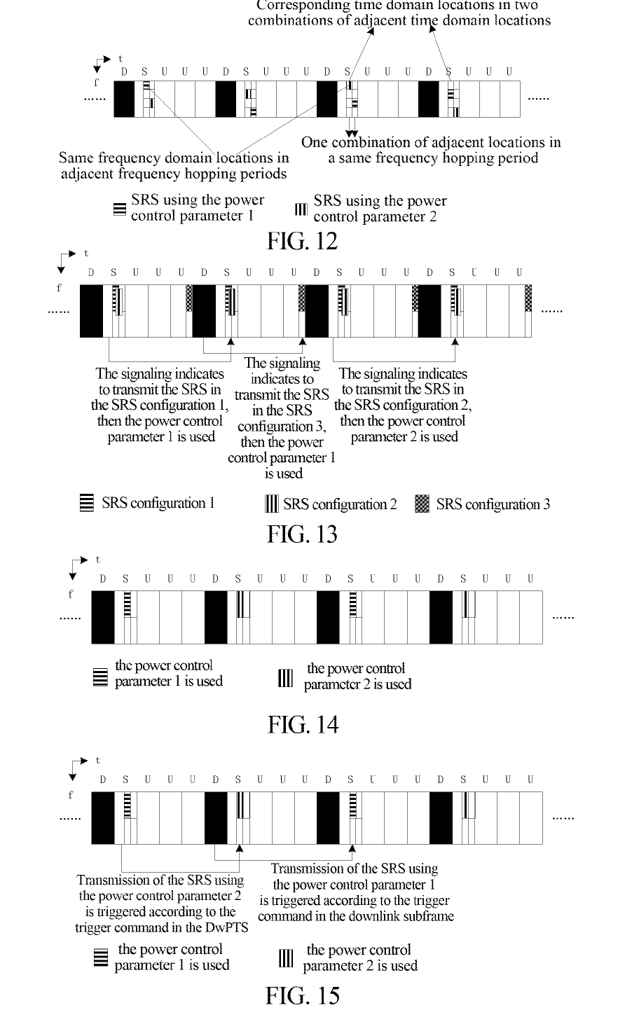

FIG. 12 shows the case of alternately using the same or different power control parameters at adjacent SRS transmission time points when there are four frequency domain hopping locations: the power control parameters used by the terminal at the same frequency domain locations in adjacent frequency hopping periods are different; within a same frequency hopping period, different power control parameters are alternately used at corresponding time domain locations in the combinations of adjacent two time domain locations within a same frequency hopping period (the number of combinations of adjacent locations within one frequency hopping period is 2).

### The Sixth Embodiment

One power control parameter consists of P_{O}_{_}_{PUSCH,c} and f_{c}. There are two power control parameters in total, respectively a power control parameter 1: <P¹_{O}_{_}_{PUSCH,c}, f_{c}¹> and a power control parameter 2: <P²_{O}_{_}_{PUSCH,c}, f_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH,c} or different P_{O}_{_}_{UE}_{_}_{PUSCH,c} or different P_{O}_{_}_{NOMINAL}_{_}_{PUSCH,c} and P_{O}_{_}_{UE}_{_}_{PUSCH,c}.

Determining the power control parameters used by the SRS resources according to the signaling indication can be implemented specifically by means of:

the base station configuring the terminal with 3 SRS configurations, respectively: an SRS configuration 1: the frequency domain comb configuration is 0; the starting physical resource block index is 0; the period and subframe offset configuration is 10 (see Table 3, the period is 5 ms, and the subframe configuration is 0);

an SRS configuration 2: the frequency domain comb configuration is 1; the starting physical resource block index is 0; the period and subframe offset configuration is 10 (see Table 3, the period is 5 ms, and the subframe configuration is 0);

an SRS configuration 3: the frequency domain comb configuration is 0; the starting physical resource block index is 0; the period and subframe offset configuration is 14 (see Table 3, the period is 5 ms, and the subframe configuration is 4);

the SRS bandwidth configuration, the cyclic shift configuration and the configuration of the number of antenna ports of the three SRS configurations are all the same.

The SRS configurations 1 and 3 correspond to the power control parameter 1; the SRS configuration 2 corresponds to the power control parameter 2.

As shown in FIG. 13, when the signaling indicates to transmit the SRS configurations 1 and 3, the power control parameter 1 is used to transmit the SRS; when the signaling indicates to transmit the SRS configuration 2, the power control parameter 2 is used to transmit the SRS;

the timing relationship between the signaling and the SRS transmission location is: the time domain location of the signaling is the subframe n, then the time domain location for transmitting the SRS is n+k, wherein k>=4 and the subframes n+k are uplink subframes containing specific SRS configuration resources.

### The Seventh Embodiment

One power control parameter consists of P_{O}_{_}_{PUSCH,c}, α_{c} and f_{c}. There are two power control parameters in total, respectively a power control parameter 1: <P¹_{O}_{_}_{PUSCH,c}, α¹_{c}, f_{c}¹> and a power control parameter 2: <P²_{O}_{_}_{PUSCH,c}, α_{c}², f_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P¹_{O}_{_}_{PUSCH,c} may have different P_{O}_{_}_{NOMINAL}_{_}_{PUSCH,c} or different P_{O}_{_}_{UE}_{_}_{PUSCH,c} or different P_{O}_{_}_{NOMINAL}_{_}_{PUSCH,c} and P_{O}_{_}_{UE}_{_}_{PUSCH,c}.

SRS resources refer to: time domain location. Different SRS resources using different power control parameters refers to using different power control parameters at different time domain locations.

The SRS resources are within the UpPTS, and the period is 5 ms, the first symbol within the UpPTS is used for the SRS and the SRS resources are used for the Trigger type1 SRS or the Trigger type0 SRS.

FIG. 14 shows the case of alternately using the power control parameters 1 and 2 in each time domain position for the Trigger type0 SRS.

FIG. 15 shows the case of alternately using the power control parameters 1 and 2 at each possible time domain location for the Trigger type1 SRS. Wherein, the timing relationship between the trigger command of the Trigger type1 SRS and the actual SRS transmission location is that: the time domain location of the signaling is a subframe n, the time domain location for transmitting the SRS is n+k, wherein k>=4 and the subframes n+k are uplink subframes comprising specific SRS configuration resources.

### The Eighth Embodiment

One power control parameter consists of P_{O}_{_}_{PUSCH,c} and α_{c}. There are two power control parameters in total, respectively a power control parameter 1: <P¹_{O}_{_}_{PUSCH,c}, α_{c}¹> and a power control parameter 2: <P²_{O}_{_}_{PUSCH,c}, α_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH,c}, or different P_{O}_{_}_{UE}_{_}_{PUSCH,c}, or different P_{O}_{_}_{NOMINAL}_{_}_{PUSCH,c} and P_{O}_{_}_{UE}_{_}_{PUSCH,c}.

2 SRS processes are configured. Time domain locations of the two SRS processes are different (individually configured through the period and subframe offset).

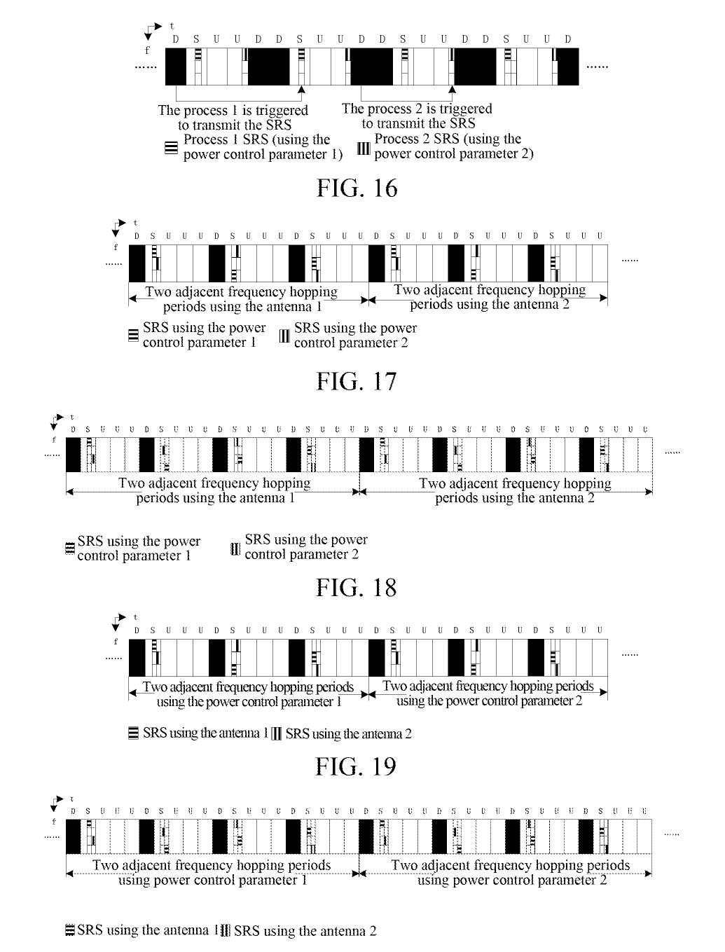

As shown in FIG. 16, for the Trigger type1 SRS, it is assumed that the period of the process 1 is 5 ms, and the subframe offset is 0; the period of the process 2 is 5 ms, and the subframe offset is 3; the process 1 uses the power control parameter 1 and the process 2 uses the power control parameter 2. Wherein, the timing relationship between the trigger command of the Trigger type1 SRS and the actual SRS transmission location is that: the time domain location of the signaling is a subframe n, the time domain location for transmitting the SRS is n+k, wherein k>=4 and the subframes n+k are uplink subframes containing SRS resources (it may be the SRS resources of the process 1 or the process 2).

In addition, the processes 1 and 2 may also use different frequency domain combs, for example, the process 1 uses a frequency domain comb configuration 0 and the process 2 uses a frequency domain comb configuration 1; the processes 1 and 2 may also use different cyclic shifts, for example, the process 1 uses a cyclic shift 0 and the process 2 uses a cyclic shift 4; the processes 1 and 2 may also use different frequency domain locations (individually configured through the frequency domain starting PRB and/or the frequency hopping parameter); the processes 1 and 2 may also use different bandwidths.

### The Ninth Embodiment

One power control parameter consists of P_{O}_{_}_{PUSCH,c} and f_{c}. There are two power control parameters in total, respectively a power control parameter 1: <P¹_{O}_{_}_{PUSCH,c}, f_{c}¹> and a power control parameter 2: <P²_{O}_{_}_{PUSCH,c}, f_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH,c}, or different P_{O}_{_}_{UE}_{_}_{PUSCH,c}, or different P_{O}_{_}_{NOMINAL}_{_}_{PUSCH,c} and P_{O}_{_}_{UE}_{_}_{PUSCH,c}.

SRS resources refer to: time domain location and/or frequency domain location. Different SRS resources using different power control parameters refers to using different power control parameters at different time domain locations and/or frequency domain locations.

It is assumed that the Trigger type0 SRS is transmitted within the UpPTS, and two symbols within one UpPTS are used for the SRS (2 ms period).

Two antennas are utilized to open an antenna selection function.

FIG. 17 shows the case of, after alternately using two power control parameters to transmit the SRS at the same frequency domain locations in adjacent two frequency hopping periods by using one antenna when there are three frequency domain hopping locations, the terminal alternately using two power control parameters to transmit the SRS at the same frequency domain locations in another adjacent two frequency hopping periods by using the other antenna. Within a same frequency hopping period, different power control parameters are alternately used between adjacent time domain locations.

FIG. 18 shows the case of, after alternately using two power control parameters to transmit the SRS at the same frequency domain locations in adjacent two frequency hopping periods by using one antenna when there are four frequency domain hopping locations, the terminal alternately using two power control parameters to transmit the SRS at the same frequency domain locations in another adjacent two frequency hopping periods by using the other antenna. Within a same frequency hopping period, different power control parameters are alternately used at the corresponding time domain locations in the combinations of adjacent two time domain locations within a same frequency hopping period.

### The Tenth Embodiment

One power control parameter consists of P_{O}_{_}_{PUSCH,c} and f_{c}. There are two power control parameters in total, respectively a power control parameter 1: <P¹_{O}_{_}_{PUSCH,c}, f_{c}¹> and a power control parameter 2: <P²_{O}_{_}_{PUSCH,c}, f_{c}²>.

Note: P_{O}_{_}_{PUSCH,c} consists of two parts: P_{O}_{_}_{NOMINAL}_{_}_{PUSCH,c} and P_{O}_{_}_{UE}_{_}_{PUSCH,c}. Therefore, P¹_{O}_{_}_{PUSCH,c} and P²_{O}_{_}_{PUSCH,c} may have different P_{O}_{_}_{NOMINAL}_{_}_{PUSCH} or different P_{O}_{_}_{UE}_{_}_{PUSCH,c}, or different P_{O}_{_}_{NOMINAL}_{_}_{PUSCH,c} and P_{O}_{_}_{UE}_{_}_{PUSCH,c}.

SRS resources refer to: time domain location and/or frequency domain location. Different SRS resources using different power control parameters refers to using different power control parameters at different time domain locations and/or frequency domain locations.

It is assumed that the Trigger type0 SRS is transmitted within the UpPTS, and two symbols within one UpPTS are used for the SRS (2 ms period).

Two antennas are utilized to open an antenna selection function.

FIG. 19 shows the case of, when there are three frequency domain hopping locations, after alternately using two antennas to transmit the SRS at the same frequency domain locations in adjacent two frequency hopping periods by using one power control parameter, the terminal alternately using two antennas to transmit the SRS at the same frequency domain locations in another two adjacent frequency hopping periods by using the other power control parameter and. Different antennas are alternately used between adjacent time domain locations within a same frequency hopping period.

FIG. 20 shows the case of, when there are four frequency domain hopping locations, after alternately using two antennas to transmit the SRS at the same frequency domain locations in adjacent two frequency hopping periods by using one power control parameter, the terminal alternately using two antennas to transmit the SRS at the same frequency domain locations in another two adjacent frequency hopping periods by using the other power control parameter. Different antennas are alternately used at the corresponding time domain locations in the combinations of adjacent two time domain locations within a same frequency hopping period. (herein, the number of combinations of adjacent locations within one frequency hopping period is 2).

### Apparatus Embodiment

The embodiment of the present document discloses a system for configuring power control parameters of sounding reference signals in a time division duplex system, applied to a terminal and a base station, as shown in FIG. 23 and FIG. 24:

a system for configuring power control parameters of sounding reference signals in a time division duplex system, applied to a terminal, including:

a power control parameter determining module, used to determine power control parameters of sounding reference signal SRS resources;

a transmission power determining module, used to determine the transmission power of the sounding reference signals according to the power control parameters;

a transmitting module, used to transmit the sounding reference signals SRS according to the determined transmission power of the sounding reference signals SRS.

A system for configuring power control parameters of sounding reference signals in a time division duplex system, applied to a base station, comprising:

a power control parameter determining module, used to determine power control parameters used by a terminal in SRS resources;

a receiving module, used to receive the SRS signals according to the power control parameters.

The above description is only the preferred embodiments of the present document, and is not intended to limit the present document. For those people skilled in the field, the present document may have various modifications and changes. Any modifications, equivalent replacements and improvements made within the spirit and principle of the present document should be included in the protection scope of the present document.

### INDUSTRIAL APPLICABILITY

The beneficial effects of the embodiments of the present document are:

(1) the flexibility is better, and the uplink resource utilization rate of the TDD mode can be improved. Based on the method proposed in the present document, the SRS using different power control parameters can be transmitted in any uplink subframes (including fixed uplink subframes, dynamic subframes and UpPTS), and it is not required that the SRS period be less than 5 ms. When the SRS is transmitted in the UpPTS, the uplink subframe resources can be saved for data transmission. When the SRS period is greater than 5 ms, the SRS overhead can be reduced.

(2) when the transmission direction of the subframes is changed, the transmission of SRS with different power control parameters and the corresponding channel measurement are not affected, which ensures the PUSCH power control and link adaptation performance of each subframe group.

(3) the method provided in the embodiments of the present document supports to transmit the SRS in fixed uplink subframes for different power control parameters, thus the dependence on the subframe transmission direction related signaling is not high

What is claimed is:

1. A method for configuring power control parameters of sounding reference signals in a time division duplex system, applied to a terminal, comprising:
a terminal determining power control parameters of sounding reference signal, SRS, resources, and determining transmission power of sounding reference signals according to the power control parameters;
the terminal transmitting the SRS according to determined transmission power of the SRS.

2. The method of claim 1, wherein,
the power control parameters comprise at least one of the following: P_{O}_{_}_{PUSCH,c}, α_{c}, f_{c}, P_{O}_{_}_{NOMINAL}_{_}_{PUSCH,c} and P_{O}_{_}_{UE}_{_}_{PUSCH,c} wherein, f_{c} is a power control adjustment state of a current PUSCH in a cell c based on a TPC (Transmit Power Control) command; P_{O}_{_}_{PUSCH,c} P_{O}_{_}_{NOMINAL}_{_}_{PUSCH,c}, P_{O}_{_}_{UE}_{_}_{PUSCH,c} and α_{c} are power control parameters used by a physical uplink shared channel, PUSCH, P_{O}_{_}_{NOMINAL}_{_}_{PUSCH,c} is a cell-specific parameter; P_{O}_{_}_{UE}_{_}_{PUSCH,c} is a terminal-specific parameter; and P_{O}_{_}_{PUSCH,c}=P_{O}_{_}_{NOMINAL}_{_}_{PUSCH,c}+P_{O}_{_}_{UE}_{_}_{PUSCH,c}.

3. The method of claim 1, wherein,
said determining the transmission power according to the power control parameters comprises one of the following variables or the sum of a plurality of the following variables: P_{O}_{_}_{PUSCH,c}, α_{c}·PL_{c}, f_{c}, wherein, a unit of P_{O}_{_}_{PUSCH,c} is dBm, and a unit of f_{c} and PL_{c} is dB.

4. The method of claim 1, wherein the SRS resources comprise at least one of the following: a time domain location, a frequency domain location, a frequency domain comb, and a sequence cyclic shift.

5. The method of claim 1, wherein,
the terminal determining the power control parameters of the SRS resources comprises:
the terminal determining the power control parameters according to SRS processes configured by a base station, wherein different SRS processes comprise different SRS resources, and the different SRS resources or different SRS processes correspond to different power control parameters.

6. The method of claim 5, wherein, when there is one SRS process, SRS resources corresponding to the SRS process use same power control parameters.

7. The method of claim 6, wherein, when all subframes for the terminal transmitting the physical uplink shared channel, PUSCH, belong to one subframe group, the number of the SRS processes is 1.

8. The method of claim 1, wherein,
the terminal determining the power control parameters of the SRS resources comprises:
the terminal determining power control parameters used at different time domain locations.

9-11. (canceled)

12. The method of claim 8, wherein,
when there are two power control parameters and two antennas are utilized to start an antenna selection function, after the terminal alternately uses two power control parameters to transmit the SRS at same frequency domain locations in adjacent two frequency hopping periods by using one antenna, the terminal alternately uses two power control parameters to transmit the SRS at same frequency domain locations in another adjacent two frequency hopping periods by using the other antenna.

13. (canceled)

14. The method of claim 8, wherein, when there are two power control parameters and two antennas are utilized to start an antenna selection function, after the terminal alternately uses two antennas to transmit the SRS at same frequency domain locations in adjacent two frequency hopping periods by using one power control parameter, the terminal alternately uses two antennas to transmit the SRS at same frequency domain locations in another adjacent two frequency hopping periods by using the other power control parameter.

15. The method of claim 14, wherein,
different antennas are used alternately between adjacent time domain locations in a same frequency hopping period, and/or, different antennas are used alternately at corresponding time domain locations in combinations of adjacent two time domain locations in a same frequency hopping period.

16. The method of claim 1, wherein,
the terminal determining power control parameters of the SRS resources comprises:
the terminal determining the power control parameters of the SRS resources according to a signaling indication of the base station.

17. The method of claim 16, wherein,
the terminal determining the power control parameters of the SRS resources according to the signaling indication of the base station comprises:
the terminal receiving a physical layer signaling from the base station, when the signaling indicates an SRS resource configuration used by the terminal, the terminal determining power control parameters corresponding to the SRS resource configuration according to an association relationship between SRS resource configurations and power control parameters.

18. The method of claim 17, wherein, the physical layer signaling is a DCI (Downlink Control Information) format 4.

19. The method of claim 17, wherein, the SRS resource configurations comprise at least one of the following: a frequency domain comb configuration, a starting physical resource block index, a period and subframe offset configuration, an SRS bandwidth configuration, a sequence cyclic shift configuration and a configuration of the number of antenna ports.

20. The method of claim 1, wherein,
the SRS resources are used for a trigger type0 SRS and/or a trigger type1 SRS.

21. The method of claim 20, wherein,
when the SRS resources are used for the trigger type1 SRS, the terminal determines a time domain location for transmitting the SRS and corresponding power control parameters according to a time domain location of a physical layer trigger signaling.

22. The method of claim 21, wherein, the terminal determining the time domain location for transmitting the SRS according to the time domain location of the physical layer trigger signaling comprises:
if the time domain location of the physical layer trigger signaling is a subframe n, the time domain location for transmitting the SRS being n+k, wherein k≧4 and subframes n+k are uplink subframes comprising the SRS resources.

23. The method of claim 22, wherein,
the uplink subframes comprise fixed uplink subframes and/or uplink subframes converted from dynamic subframes, and the dynamic subframes are subframes with different periods and transmission directions, and the periods are less than 640 milliseconds.

24. (canceled)

25. A method for configuring power control parameters of sounding reference signals in a time division duplex system, applied to a base station, comprising:
the base station determining power control parameters used by a terminal in SRS resources;
the base station receiving SRS signals according to the power control parameters.

26-48. (canceled)

49. A system for configuring power control parameters of sounding reference signals in a time division duplex system, applied to a terminal, comprising:
a power control parameter determining module, configured to: determine power control parameters of sounding reference signal, SRS, resources;
a transmission power determining module, configured to: determine transmission power of the sounding reference signals according to the power control parameters;
a transmitting module, configured to: transmit the SRS according to determined transmission power of the SRS.

50. A system for configuring power control parameters of sounding reference signals in a time division duplex system, applied to a base station, comprising:
a power control parameter determining module, configured to: determine power control parameters used by a terminal in SRS resources;
a receiving module, configured to: receive SRS signals according to the power control parameters.
